(19) United States
(12) Patent Application Publication
(10) Pub. No.: US 2007/0045254 A1
(43) Pub. Date: Mar. 1, 2007

(54) Wafer drilling method

(75) Inventor: Hiroshi Morikazu, Tokyo (JP)

Correspondence Address: SMITH, GAMBRELL & RUSSELL, 1850 M STREET, N.W., SUITE 800, WASHINGTON, DC, 20036, US

(73) Assignee: Disco Corporation

(21) Appl. No.: 11/506,911

(22) Filed: Aug. 21, 2006

(30) Foreign Application Priority Data
Aug. 30, 2005 (JP) 2005-249643

(51) Int. Cl. B23K 26/38

(52) U.S. Cl. 219/121.71

(57) ABSTRACT

A wafer drilling method for forming via holes reaching electrodes in a wafer having a plurality of devices formed on the front surface of a substrate and electrodes formed on the devices by applying a pulse laser beam from the rear surface side of the substrate, wherein a material forming the substrate, a material forming the electrodes and a wavelength of the pulse laser beam are selected based on absorptivity for the wavelength of the pulse laser beam, and the material forming the substrate, the material forming the electrodes and the wavelength of the pulse laser beam are set to ensure that the absorptivity of the electrodes for the wavelength of the pulse laser beam becomes lower than the absorptivity of the substrate for the wavelength of the pulse laser beam.

### FIELD OF THE INVENTION

The present invention relates to a wafer drilling method for forming via holes reaching electrodes from the rear surface of a substrate in a wafer having a plurality of devices on the front surface of the substrate and electrodes formed on the devices.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer, and a device such as IC or LSI is formed in each of the sectioned areas. Individual semiconductor chips are manufactured by cutting this semiconductor wafer along the streets to divide it into the areas in each of which the device is formed.

To reduce the size and increase the sophisticated functions of an apparatus, a modular structure for connecting the electrodes of a plurality of semiconductor chips which are stacked up in layers is disclosed by JP-A 2003-163323. This modular structure is a structure in which electrodes are formed on the front surface of a semiconductor wafer, via holes reaching the electrodes from the rear surface side of the wafer are formed at positions where the electrodes are formed, and a conductive material such as aluminum for connecting the electrodes is buried in the via holes.

The above via holes in the semiconductor wafer are generally formed by a drill. Therefore, the diameters of the via holes formed in the semiconductor wafer are as small as 100 to 300 μm, and the formation of via holes by the drill is not always satisfactory in terms of productivity. In addition, as the thickness of each of the above electrodes is about 1 to 5 μm, the drilling must be controlled extremely precisely in order to form the via holes only in the substrate forming the wafer such as a silicon substrate, without damaging the electrodes.

### SUMMARY OF THE INVENTION

It is an object of the present invention to provide a wafer drilling method capable of drilling via holes reaching electrodes from the rear surface side of a substrate in a wafer having a plurality of devices on the front surface of the substrate and electrodes formed on the devices, efficiently without damaging the electrodes.

To attain the above object, according to the present invention, there is provided a wafer drilling method for forming via holes reaching electrodes in a wafer having a plurality of devices formed on the front surface of a substrate and electrodes formed on the devices by applying a pulse laser beam from the rear surface side of the substrate, wherein

a material forming the substrate, a material forming the electrodes and a wavelength of the pulse laser beam are selected based on absorptivity for the wavelength of the pulse laser beam, and the material forming the substrate, the material forming the electrodes and the wavelength of the pulse laser beam are set to ensure that the absorptivity of the electrodes for the wavelength of the pulse laser beam becomes lower than the absorptivity of the substrate for the wavelength of the pulse laser beam.

The above substrate is made of silicon, the above electrodes are made of aluminum, and the wavelength of the above pulse laser beam is set to 355 nm. It is desired that the wafer should be cooled to prevent the electrodes from reaching their melting point at the time of applying the pulse laser beam.

According to the present invention, there is further provided a wafer drilling method for forming via holes reaching electrodes in a wafer having a plurality of devices on the front surface of a substrate and electrodes formed on the devices by applying a pulse laser beam from the rear surface side of the substrate, wherein

a material forming the substrate, a material forming the electrodes and a wavelength of the pulse laser beam are selected based on the melting points and absorptivities for the wavelength of the pulse laser beam of the materials forming the substrate and the electrodes, and the material forming the substrate, the material forming the electrodes and the wavelength of the pulse laser beam are set to ensure that the substrate reaches its melting point but the electrodes do not reach their melting point.

The above substrate is made of silicon, the above electrodes are made of any one of gold, titanium, tantalum and tungsten, and the wavelength of the above pulse laser beam is set to 532 nm.

According to the present invention, since the material forming the substrate, the material forming the electrodes and the wavelength of the pulse laser beam are selected based on absorptivity for the wavelength of the pulse laser beam, and the material forming the substrate, the material forming the electrodes and the wavelength of the pulse laser beam are set to ensure that the absorptivity of the electrodes for the wavelength of the pulse laser beam becomes smaller than the absorptivity of the substrate for the wavelength of the pulse laser beam, the via holes reaching the electrodes can be formed from the rear surface of the substrate efficiently without melting the electrodes.

According to the present invention, since the material forming the substrate, the material forming the electrodes and the wavelength of the pulse laser beam are selected based on the melting points and absorptivities for the wavelength of the pulse laser beam of the materials forming the substrate and the electrodes, and the material forming the substrate, the material forming the electrodes and the wavelength of the pulse laser beam are set to ensure that the substrate reaches its melting point but the electrodes do not reach their melting point, the via holes reaching the electrodes from the rear surface of the substrate can be formed efficiently without melting the electrodes.

### BRIEF DESCRIPTION OF THE DRAWINGS

FIG. 1 is a perspective view of a semiconductor wafer as a wafer to be processed by the wafer drilling method of the present invention;

FIG. 2 is a perspective view of the principal section of a laser beam machine for carrying out the wafer drilling method of the present invention;

FIG. 3 is an explanatory diagram showing a laser beam application step in the wafer drilling method of the present invention;

FIG. 4 is a partially enlarged sectional view of a semiconductor wafer having via holes formed by the wafer drilling method of the present invention;

FIG. 5 is a table showing the absorptivities for a pulse laser beam having a wavelength of 355 nm and melting points of silicon and metal materials; and

FIG. 6 is a table showing the absorptivities for a pulse laser beam having a wavelength of 532 nm and melting points of silicon and metal materials.

### DETAILED DESCRIPTION OF THE PREFERRED EMBODIMENTS

The wafer drilling method of the present invention will be described in more detail hereinunder with reference to the accompanying drawings.

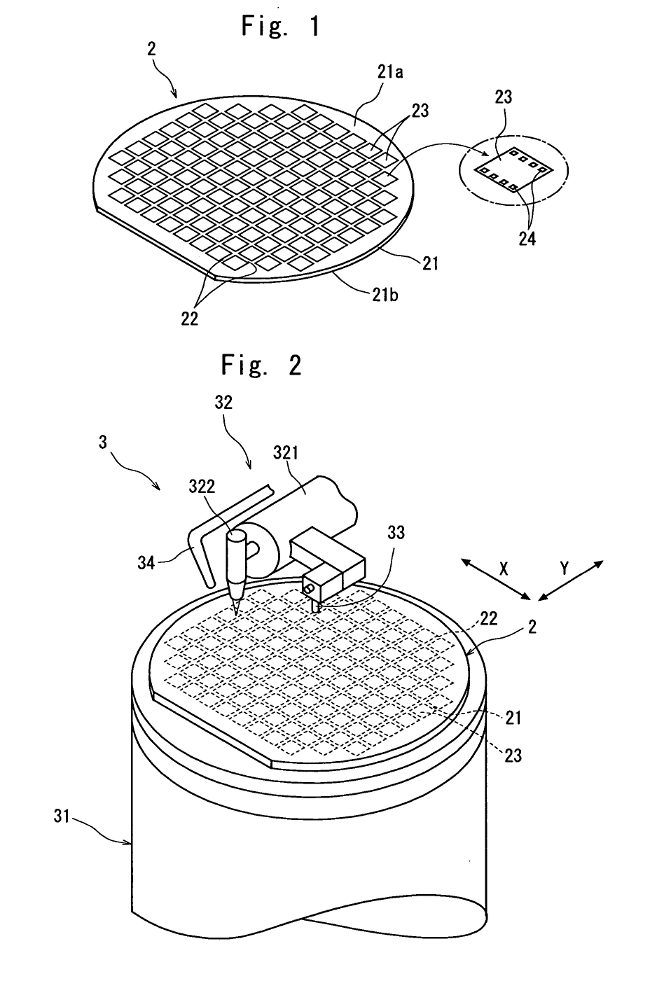

FIG. 1 is a perspective view of a semiconductor wafer as the wafer to be processed by the wafer drilling method of the present invention. In the semiconductor wafer 2 shown in FIG. 1, a plurality of areas are sectioned by a plurality of streets 22 arranged in a lattice pattern on the front surface 21a of a substrate 21 that is made of silicon and has a thickness of, for example, 100 μm, and a device 23 such as IC or LSI is formed in each of the sectioned areas. The devices 23 are the same in structure. A plurality of electrodes 24 are formed on the front surface of each device 23. The electrodes 24 are made of a metal such as aluminum, gold, titanium, tantalum or tungsten and has a thickness of 1 to 5 μm.

Via holes reaching the electrodes 24 are formed in the above semiconductor wafer 2 by applying a pulse laser beam from the rear surface 21b side of the substrate 21. To form the via holes in the substrate 21 of the semiconductor wafer 2, a laser beam machine 3 shown in FIG. 2 is used. The laser beam machine 3 shown in FIG. 2 comprises a chuck table 31 for holding a workpiece and a laser beam application means 32 for applying a laser beam to the workpiece held on the chuck table 31. The chuck table 31 is so constituted as to suction-hold the workpiece and is designed to be moved in a processing-feed direction indicated by an arrow X in FIG. 2 by a processing-feed mechanism (not shown) and an indexing-feed direction indicated by an arrow Y by an indexing-feed mechanism that is not shown.

The above laser beam application means 32 applies a pulse laser beam from a condenser 322 mounted on the end of a cylindrical casing 321 arranged substantially horizontally. The illustrated laser beam machine 3 comprises an image pick-up means 33 mounted on the end portion of the casing 321 constituting the above laser beam application means 32. This image pick-up means 33 comprises an infrared illuminating means for applying infrared radiation to the workpiece, an optical system for capturing infrared radiation applied by the infrared illuminating means, and an image pick-up device (infrared CCD) for outputting an electric signal corresponding to infrared radiation captured by the optical system, in addition to an ordinary image pick-up device (CCD) for picking up an image with visible radiation. An image signal is supplied to a control means (not shown) which will be described later. The illustrated laser beam machine 3 comprises a cooling gas ejection nozzle 34 for ejecting a jet of a cooling gas such as helium gas, tetrafluoroethane or the like to the application area of a pulse laser beam applied from the above condenser 322. This cooling gas ejection nozzle 34 is connected to a cooling gas supply means that is not shown.

A description will be subsequently given of the wafer drilling method which is carried out by using the above laser beam machine 3.

The front surface 21a of the semiconductor wafer 2 is first placed on the chuck table 31 of the laser beam machine 3 shown in FIG. 2 and suction-held on the chuck table 51. Therefore, the rear surface 21b of the semiconductor wafer 2 faces up.

The chuck table 31 suction-holding the semiconductor wafer 2 as described above is brought to a position right below the image pick-up means 33 by the processing-feed mechanism that is not shown. After the chuck table 31 is positioned right below the image pick-up means 33, the semiconductor wafer 2 on the chuck table 31 becomes a state where it is located at a predetermined coordinate position. In this state, alignment work for checking whether the streets 22 formed in a lattice pattern on the semiconductor wafer 2 held on the chuck table 31 are parallel to the X direction and the Y direction is carried out. That is, the image pick-up means 33 picks up an image of the semiconductor wafer 2 held on the chuck table 31 and carries out image processing such as pattern matching, etc. to perform the alignment work. Although the front surface 21a on which the street 22 of the semiconductor wafer 2 is formed, of the substrate 21 faces down at this point, images of the streets 21 can be picked up through the rear surface 21b of the substrate 21 as the image pick-up means 33 is constituted by an infrared illuminating means, an optical system for capturing infrared radiation and an image pick-up device (infrared CCD) for outputting an electric signal corresponding to the infrared radiation as described above.

By carrying out the above-described alignment work, the semiconductor wafer 2 held on the chuck table 31 is located at the predetermined coordinate position. The designed coordinate positions of the plurality of electrodes 24 formed on the devices 23 on the front surface 21a of the substrate 21 of the semiconductor wafer 2 are stored in the control means (not shown) of the laser beam machine 3 in advance.

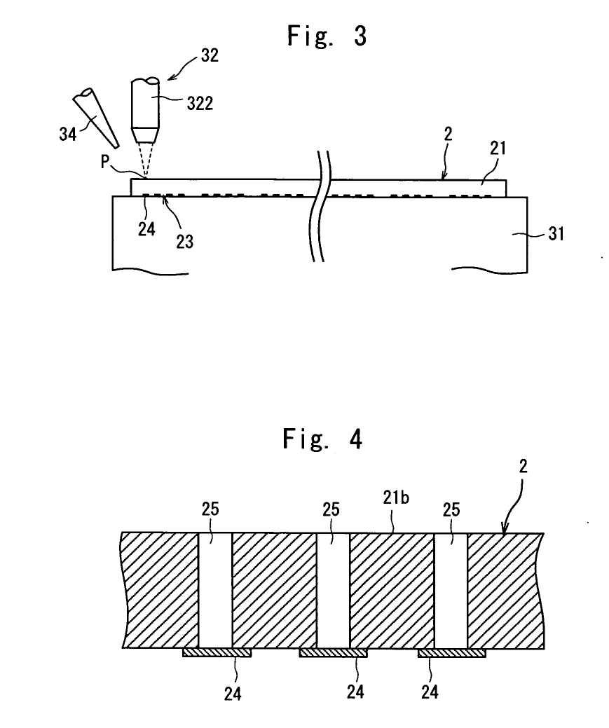

After the above alignment work is carried out, the chuck table 31 is moved as shown in FIG. 3 to bring a device 23 at the most left end in FIG. 3 out of the plurality of devices 23 formed on the substrate 21 of the semiconductor wafer 2 in a predetermined direction to a position right below the condenser 322. Then, an electrode 24 at the most left end out of the plurality of electrodes 24 formed on the device 23 at the most left end in FIG. 3 is positioned right below the condenser 322.

Next comes a laser beam application step for applying a pulse laser beam from the condenser 322 by activating the laser beam application means 32 to form via holes reaching the electrodes 24 from the rear surface 21b of the substrate 21 of the semiconductor wafer 2.

A description will be first given of a first embodiment of the laser beam application step.

In the first embodiment, the material forming the substrate 21, the material forming the electrodes 24 and the wavelength of the pulse laser beam are selected based on absorptivity for the wavelength of the pulse laser beam. That is, the material forming the substrate 21, the material forming the electrodes 24 and the wavelength of the pulse laser beam are set to ensure that the absorptivity of the electrodes 24 for the wavelength of the pulse laser beam should become lower than that of the substrate 21 for the wavelength of the pulse laser beam. More specifically, in this embodiment, the substrate 21 of the semiconductor wafer 2 is made of silicon, the electrodes 24 are made of aluminum, and the wavelength of the pulse laser beam applied from the condenser is set to 355 nm.

That is, after the electrode 24 at the most left end out of the plurality of electrodes 24 formed on the device 23 at the most left end in FIG. 3 is brought to a position right below the condenser 322, the laser beam application means 32 is activated to apply a pulse laser beam having a wavelength of 355 nm from the condenser 322. At this point, the focal spot P of the pulse laser beam is set to a position near the rear surface 21b of the substrate 21 of the semiconductor wafer 2. In this laser beam application step, a jet of a cooling gas such as helium gas or tetrafluoroethane is ejected to the application area of the pulse laser beam from the cooling gas ejection nozzle 34.

The processing conditions of the first embodiment in this laser beam application step are set as follows.

Light source of laser beam: YVO4 laser or YAG laser

Wavelength: 355 nm

Repetition frequency: 2 kHz

Pulse energy: 0.1 mj

Focal spot diameter: 10 μm

When the substrate 21 of the semiconductor wafer 2 is made of silicon, a 5 μm-deep hole can be formed with one pulse laser beam under the above processing conditions. Therefore, when the thickness of the substrate 21 is 100 μm, a via hole 25 extending from the rear surface 21b to the front surface 21a, that is, a via hole 25 reaching the electrode 24 can be formed in the substrate 21 as shown in FIG. 4 by irradiating 20 pulse laser beams.

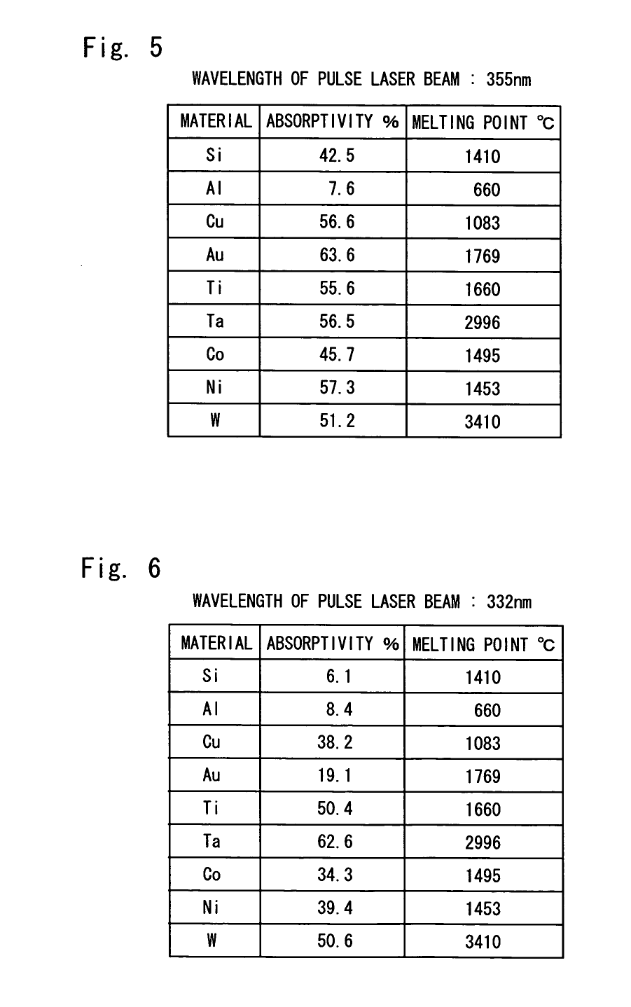

Here, the absorptivities of silicon and metal materials for the wavelength of the pulse laser beam and the melting points of silicon and metal materials will be described with reference to FIG. 5. FIG. 5 shows the absorptivities of silicon and metal materials for a pulse laser beam having a wavelength of 355 nm and the melting points of silicon and metal materials.

As shown in FIG. 5, the absorptivity of silicon (Si) forming the substrate 21 of the semiconductor wafer 2 is 42.5%. Meanwhile, it is understood that the absorptivities of other metal materials excluding aluminum (Al) which has an absorptivity of 7.6% are higher than the absorptivity of silicon (Si). When the electrodes 24 are made of a metal having higher absorptivity than the absorptivity of silicon (Si), for example, copper (Cu), a via hole 25 is formed by irradiating a pulse laser beam having a wavelength of 355 nm from the rear surface 21b side of the substrate 21 made of silicon (Si) and when this via hole 25 reaches the electrode 24, the electrode 24 absorbs the pulse laser beam and reaches its melting point to be molten. Therefore, when the substrate 21 of the semiconductor wafer 2 is made of silicon and the wavelength of the pulse laser beam is set to 355 nm, it is desired to use aluminum (Al) having lower absorptivity than the absorptivity (42.5%) of silicon (Si) as the material of the electrodes 24.

Since the melting point (660° C.) of aluminum (Al) is lower than the melting point (1,410° C.) of silicon (Si) as shown in FIG. 5, there is a possibility that the electrodes 24 made of aluminum (Al) may be molten by accumulated heat at the time when the pulse laser beam is irradiated to the substrate 21 made of silicon (Si) to form the via holes 25. Therefore, in the first embodiment, a jet of a cooling gas such as helium gas or tetrafluoroethane is ejected from the cooling gas ejection nozzle 34 to cool the pulse laser beam application area of the semiconductor wafer 2, thereby preventing the electrodes 24 made of aluminum (Al) from being molten. In the illustrated embodiment, though the cooling gas is ejected to the pulse laser beam application area, the chuck table 31 may be cooled to cool the front surface 21a side, on which the electrode 24 is formed, of the substrate 21.

After the above laser beam application step is carried out at a position corresponding to the electrode 24 at the most left end out of the plurality of electrodes 24 formed on the device 23 at the most left end in FIG. 3, the chuck table 31 is moved a distance corresponding to the interval between electrodes 24 in the processing-feed direction indicated by the arrow X in FIG. 2 to bring the adjacently formed electrode 24 to a position right below the condenser 322. Then, the above laser beam application step is carried out. After the above laser beam application step is carried out at positions corresponding to all the electrodes formed on the devices 23 in a predetermined direction as described above, the chuck table 31 is turned at 90° to carry out the above laser beam application step at positions corresponding to all the electrodes 24 formed on the devices 23 in a direction perpendicular to the above predetermined direction. As a result, via holes 25 reaching the electrodes 24 are formed from the rear surface 21b of the substrate 21 at positions corresponding to all the electrodes 24 formed on all the devices 23 on the semiconductor wafer 2. The semiconductor wafer 2 having the via holes 25 is carried to the subsequent step where a conductive material such as aluminum or the like is then buried in the via holes 25.

A description will be subsequently given of a second embodiment of the laser beam application step.

In the second embodiment, the material forming the substrate 21, the material forming the electrodes 24 and the wavelength of the pulse laser beam are selected based on the melting points of the materials forming the substrate 21 and the electrodes 24 and absorptivity for the wavelength of the pulse laser beam. That is, the material forming the substrate 21, the material forming the electrodes 24 and the wavelength of the pulse laser beam are set to ensure that the substrate 21 reaches its melting point but the electrodes 24 do not reach their melting point. More specifically, in this embodiment, the substrate 21 of the semiconductor wafer 2 is made of silicon, the electrodes 24 are made of gold (Au), titanium (Ti), tantalum (Ta) or tungsten (W), and the wavelength of the pulse laser beam applied from the condenser is set to 532 nm.

FIG. 6 shows the absorptivities for a pulse laser beam having a wavelength of 532 nm, which have been applied to silicon and metal materials, and melting points of the silicon and metal materials.

As shown in FIG. 6, silicon (Si) forming the substrate 21 of the semiconductor wafer 2 has a melting point of 1, 410° C. and an absorptivity for a pulse laser beam having a wavelength of 532 nm of 6.1%. Although silicon has low absorptivity for the pulse laser beam having a wavelength of 532 nm, the temperature of the silicon substrate is increased up to about 1,500° C. by a heat accumulating effect. Therefore, via holes can be formed by applying a pulse laser beam having a wavelength of 532 nm to the substrate 21 made of silicon (Si). Meanwhile, gold (Au), titanium (Ti), tantalum (Ta) and tungsten (W) have a melting point of 1,600° C. or higher which is higher than the temperature (1,500° C.) attained by the heat accumulating effect, of silicon (Si). Therefore, they do not reach their melting points and are not molten. Accordingly, when the substrate 21 of the semiconductor wafer 2 is made of silicon, the electrodes 24 are made of any one of gold (Au), titanium (Ti), tantalum (Ta) and tungsten (W), and the wavelength of the pulse laser beam applied from the condenser is set to 532 nm, via holes 25 reaching the electrodes 24 from the rear surface 21b can be formed in the substrate 21 of the semiconductor wafer 2 without melting the electrodes 24.

Although cobalt (Co) and nickel (Ni) have a higher melting point than silicon (Si), their melting points are lower than the temperature (1,500° C.) of silicon (Si) attained by the heat accumulating effect at the time of applying a pulse laser beam and their absorptivities are higher than that of silicon (Si). Therefore, they are molten by the pulse laser beam at the time of forming via holes in the substrate 21 if they are used in the electrodes.

What is claimed is:

1. A wafer drilling method for forming via holes reaching electrodes in a wafer having a plurality of devices formed on the front surface of a substrate and electrodes formed on the devices by applying a pulse laser beam from the rear surface side of the substrate, wherein
a material forming the substrate, a material forming the electrodes and a wavelength of the pulse laser beam are selected based on absorptivity for the wavelength of the pulse laser beam, and the material forming the substrate, the material forming the electrodes and the wavelength of the pulse laser beam are set to ensure that the absorptivity of the electrodes for the wavelength of the pulse laser beam becomes lower than the absorptivity of the substrate for the wavelength of the pulse laser beam.

2. The wafer drilling method according to claim 1, wherein the substrate is made of silicon, the electrodes are made of aluminum, and the wavelength of the pulse laser beam is set to 355 nm.

3. The wafer drilling method according to claim 1, wherein the wafer is cooled to prevent the electrodes from reaching their melting point at the time of applying the pulse laser beam.

4. A wafer drilling method for forming via holes reaching electrodes in a wafer having a plurality of devices formed on the front surface of a substrate and electrodes formed on the devices by applying a pulse laser beam from the rear surface side of the substrate, wherein
a material forming the substrate, a material forming the electrodes and a wavelength of the pulse laser beam are selected based on the melting points of the materials forming the substrate and the electrodes and absorptivities for the wavelength of the pulse laser beam, and the material forming the substrate, the material forming the electrodes and the wavelength of the pulse laser beam are set to ensure that the substrate reaches its melting point but the electrodes do not reach their melting point.

5. The wafer drilling method according to claim 4, wherein the substrate is made of silicon, the electrodes are made of any one of gold, titanium, tantalum and tungsten, and the wavelength of the pulse laser beam is set to 532 nm.
